(19) United States
(12) Patent Application Publication
(10) Pub. No.: US 2010/0187415 A1
(43) Pub. Date: Jul. 29, 2010

(54) TURBOMOLECULAR PUMP

(75) Inventors: Robert Schneiders, Lohmar (DE); Markus Henry, Koeln (DE); Gerhard Wilhelm Walter, Kerpen-Neubottenbroich (DE)

Correspondence Address: FAY SHARPE LLP, 1228 Euclid Avenue, 5th Floor, The Halle Building, Cleveland, OH, 44115, US

(73) Assignee: OERLIKON LEYBOLD VACUUM GMBH, KOELN (DE)

(21) Appl. No.: 12/663,956

(22) PCT Filed: Jun. 5, 2008
(86) PCT No.: PCT/EP2008/056991

§ 371 Date: Dec. 10, 2009

(30) Foreign Application Priority Data
Jun. 11, 2007 (DE) 10 2007 027 354.3

(51) Int. Cl. H01J 49/24; F04D 19/04; H01J 49/26

(52) U.S. Cl. 250/289; 415/220; 415/199.5

(57) ABSTRACT

A turbomolecular pump (12) has a circular intake opening (16) distal of an inlet rotor stage (18). The intake opening (16) comprises at least two opening sections (41, 42, 43) that are separated from each other.

The invention refers to a turbomolecular pump with an intake opening distal of an inlet rotor stage.

In vacuum technology, various applications are known in which two or more vacuum chambers have to be supplied with different pressure levels and/or different pump delivery rates. In prior art vacuum arrangements this is realized by supplying each individual vacuum pump through a separate turbomolecular pump. As an alternative, so-called multi-inlet turbomolecular pumps are known which have intermediate inlets besides the intake opening distal of the inlet rotor stage, which intermediate inlets are arranged between more remote rotor stages.

These known solutions are technically rather complex, require a large structural size and are characterized by intake performance losses due to rather poor conductance.

It is an object of the present invention to provide a turbomolecular pump of simple structure that is adapted to provide a plurality of pressure levels.

According to the invention, this object is achieved with the features of claim 1.

The turbomolecular pump of the present invention has at least two separated opening sections in the plane of the generally circular intake opening. The rather large-area intake opening, which generally has an annular shape and immediately adjoins the inlet rotor stage, is divided into two or more opening sections. By varying the size of the opening section and the radial position of the opening sections, the desired pressure level and pump capacity can be adjusted in accordance with the respective vacuum chamber connected therewith. Dividing the intake opening into two or more opening sections requires comparatively little technical effort. Since all opening sections lie in the plane of the intake opening, a good conductance and thus little intake performance losses can be realized although the areas of the opening sections are reduced with respect to the area of the intake opening. Further, dividing the intake opening into a plurality of opening sections is a compact solution.

In a preferred embodiment, the opening sections are separated by conduit walls. The conduit walls form conduits to which a separate vacuum chamber can be connected, respectively. The conduit walls entirely surround the respective opening section.

Preferably, the opening sections are not equal. Thus, the opening sections allow to realize different pressure levels and intake capacities. This is required with mass spectrometers, for instance, which need two different vacuum pressures.

The opening sections may take the shape of a circular surface, be annular, concentric, non-concentric and/or sector-shaped.

Preferably, the turbomolecular pump is designed as a housing-less cartridge that is inserted into the housing of an apparatus comprising the vacuum chambers. The apparatus may be a mass spectrometer, for instance. Since the turbomolecular pump is designed as a housing-less cartridge whose housing is formed by the apparatus housing or the internal structures of the apparatus housing, a separate turbomolecular pump housing can be saved. This not only saves structural space and weight, but generally also reduces the flow resistances at the inlets and the outlet of the turbomolecular pump.

The following is a detailed explanation of several embodiments of the invention with reference to the drawings.

In the Figures:

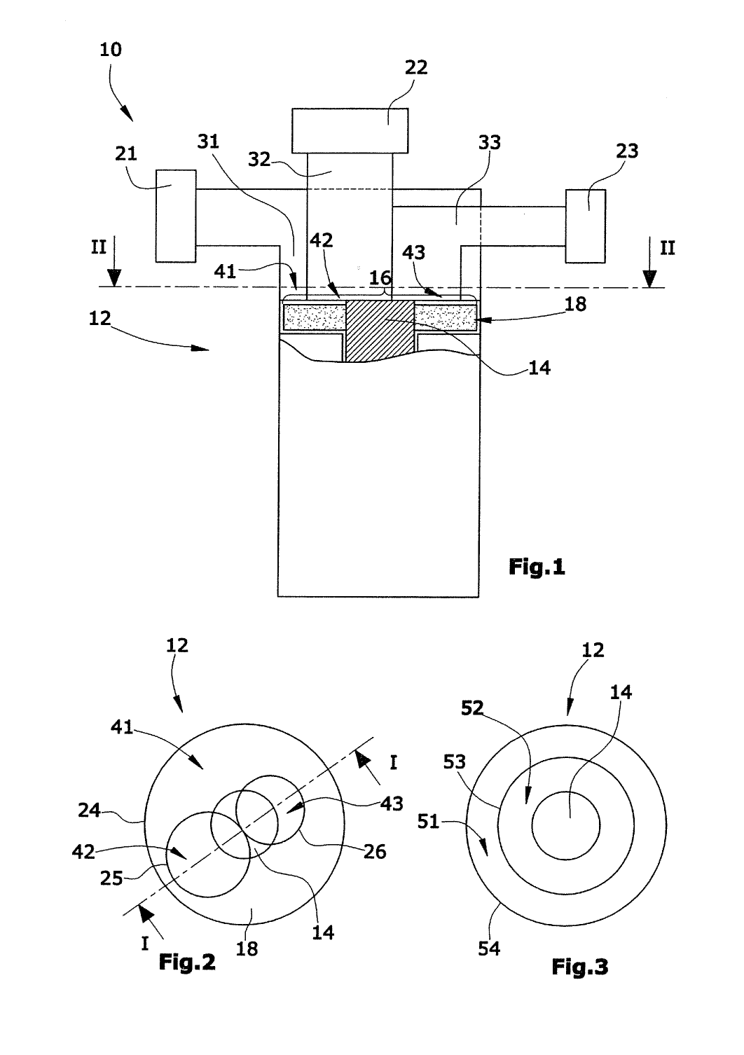

FIG. 1 is a schematic illustration of a vacuum arrangement with three vacuum chambers and a turbomolecular pump,

FIG. 2 is a section II-II in the region of the intake opening of the turbomolecular pump of FIG. 1,

FIG. 3 is a section of the intake opening of a second embodiment of a turbomolecular pump,

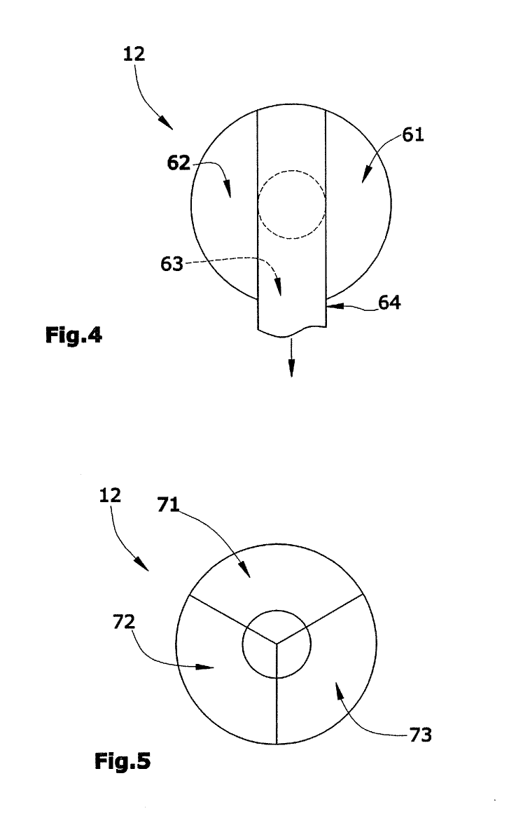

FIG. 4 is a section of the intake opening of a third embodiment of a turbomolecular pump,

FIG. 5 is a section of the intake opening of a fourth embodiment of a turbomolecular pump, and

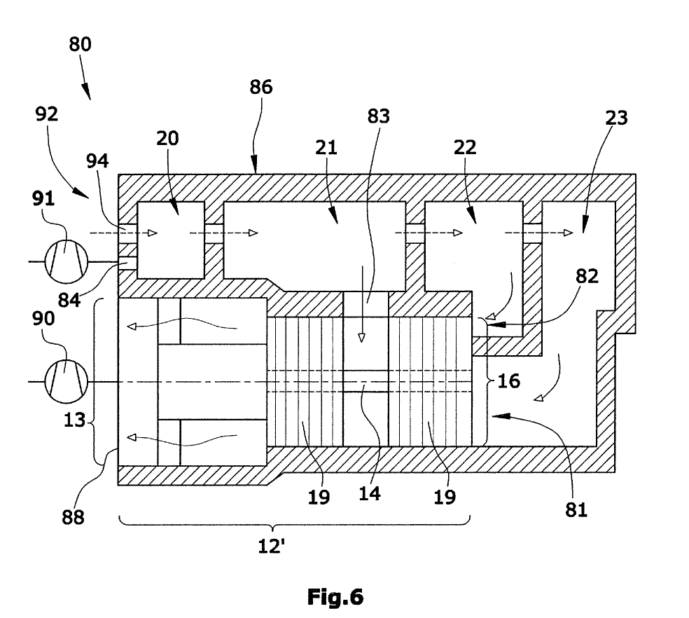

FIG. 6 a schematic illustration of a second embodiment of a vacuum arrangement with a mass spectrometer apparatus and an integrated housing-less turbomolecular pump cartridge.

FIG. 1 illustrates a vacuum arrangement 10 comprising a turbomolecular pump 12, three vacuum chambers 21, 22, 23 and vacuum conduits 31, 32, 33 connecting the same with the turbomolecular pump 12.

The turbomolecular pump 12 is a multi-stage turbopump with a plurality of rotor stages on a rotor shaft 14, of which the rotor stage closest to a circular intake opening 16 is an inlet rotor stage 18. The intake opening 16 is arranged distally from the inlet rotor stage 18 and immediately adjoins the same, i.e. it is formed by the pump housing.

The intake opening 16 of circular-surface shape is divided into three opening sections 41, 42, 43 formed by conduit walls 24, 25, 26 and separated from each other, as illustrated in FIG. 2. The rotor blades of the inlet rotor stage 18 have been omitted in FIGS. 2-5 for the sake of simplicity.

The conduits 31, 32, 33 formed by the conduit walls 24, 25, 26 have a circular cross section. Two of the three conduits 32, 33 are not arranged concentrically and have an inner diameter that is at most equal to or smaller than half the inner diameter of the overall intake opening 16. The first opening section 41 is formed by the whole area of the intake opening minus the two other opening section surfaces.

FIG. 3 illustrates a second embodiment of a turbomolecular pump 12 with an intake opening having two opening sections 51, 52 which are formed by two concentric conduit walls 53, 54 of circular cross section.

FIG. 4 illustrates a further alternative embodiment of a turbomolecular pump 12 wherein segment-shaped opening sections 61, 62 together form the opening of a first vacuum conduit, whereas the remaining portion forms an opening section 63 of a second vacuum conduit 64.

FIG. 5 illustrates another embodiment of the design of the intake opening or of the opening sections of a turbomolecular pump. Here, the opening sections 71, 72, 73 are formed as circle sectors of equal size.

FIG. 6 illustrates a second embodiment of a vacuum arrangement 80. This vacuum arrangement 80 comprises an apparatus 92 designed as a mass spectrometer into whose housing 86 a cartridge 13 is inserted that forms a turbomolecular pump 12′. A forevacuum pump 90 is connected to a forevacuum fitting 88 of the turbomolecular pump 12′ or of the cartridge 13.

The apparatus housing 86 has a total of four vacuum chambers 20, 21, 22, 23. The highest-pressure forevacuum vacuum chamber 20 with a pressure of about 2 mbar has its forevacuum fitting 94 connected with a second separate forevacuum pump 91.

The apparatus 92 may be embodied as a quadrulpol mass spectrometer, for instance, but it may also be any other type of mass spectrometer. The apparatus has three high-vacuum chambers 21, 22, 23 that are each individually connected to an intermediate inlet 83 of the turbomolecular pump or to a respective one of the opening sections 81, 82 of the turbomolecular pump inlet opening 16 and have pressure levels of 10⁻² to 10⁻⁷ mbar. In the present instance, the path of the ion current through the vacuum chambers 20, 21, 22, 23 runs from left to right through an ion current housing inlet 94 and the vacuum chambers 20, 21, 22, 23 and is indicated by broken-line arrows.

The turbomolecular pump 12′ is realized as a cartridge 13, i.e. it has no housing of its own. The turbomolecular pump cartridge 13 is set into the housing 86 of the apparatus 92 without a housing. The pump stator 19 is thus held immediately by the apparatus housing 86 or inner structures of the apparatus housing 86. Thereby, a material-saving structure is realized on the one hand. Further, the flow resistances of the different inlets of the turbomolecular pump 12′, i.e. of the intermediate inlet 83 and the opening sections 81, 82 forming inlets.

1. A turbomolecular pump with an intake opening distal of an inlet rotor stage, wherein the intake opening comprises at least two opening sections that are separated from each other.

2. The turbomolecular pump of claim 1, wherein the opening sections are separated by conduit walls.

3. The turbomolecular pump of claim 1, wherein the opening sections are shaped differently.

4. The turbomolecular pump of claim 1, wherein at least one opening section is annular.

5. The turbomolecular pump of claim 1, wherein at least one of the opening sections is circular and concentric.

6. The turbomolecular pump of claim 1, wherein at least one opening section is sector-shaped.

7. A vacuum arrangement comprising:
at least two vacuum chambers; and
a turbomolecular pump according to claim 1, wherein a respective opening section is connected with a respective one of the vacuum chambers through a respective separate vacuum conduit.

8. The vacuum arrangement of claim 7, wherein the turbomolecular pump is formed as a housing-less cartridge set into a housing of an apparatus comprising said vacuum chambers.

9. The vacuum arrangement of claim 8, wherein the apparatus is a mass spectrometer.

10. A vacuum arrangement comprising:
a turbomolecular vacuum pump including a gas intake opening at one end, a gas discharge opening and a plurality of interacting rotors and stators that pump gas from the gas intake opening to the gas discharge opening, the intake opening being divided into at least a first section and a second section;
a first vacuum chamber;
a second vacuum chamber;
a first vacuum conduct connecting the first vacuum chamber uniquely with the first intake opening section; and,
a second vacuum conduct connecting the first vacuum chamber uniquely with the first intake opening section.
